(19) United States
(12) Patent Application Publication
(10) Pub. No.: US 2015/0022425 A1
(43) Pub. Date: Jan. 22, 2015

(54) DISPLAY SYSTEM

(71) Applicant: Kabushiki Kaisha Toshiba, Tokyo (JP)

(72) Inventor: Takahisa Kaihotsu, Tokyo (JP)

(73) Assignee: Kabushiki Kaisha Toshiba, Tokyo (JP)

(21) Appl. No.: 14/168,905

(22) Filed: Jan. 30, 2014

Related U.S. Application Data
(63) Continuation of application No. PCT/JP2013/069777, filed on Jul. 22, 2013.

(51) Int. Cl. G09G 5/14

(52) U.S. Cl. CPC G09G 5/14
USPC 345/1.3

(57) ABSTRACT

According to one embodiment, a display system is provided. The display system may include a first display, and a plurality of second displays. The second displays may be arranged around the first display. A resolution of the first display may be higher than a resolution of the second displays.

### CROSS REFERENCE TO RELATED APPLICATIONS

This application is based upon and claims the benefit of priority from the prior PCT Application PCT/JP2013/69777, filed on Jul. 22, 2013, the entire contents of which are incorporated herein by reference.

### FIELD

Embodiments described herein relate generally to a display system.

### BACKGROUND

In recent years, tiling display devices appear by tiling a plurality of displays to virtually realize a large display in order to display an image with a realistic sensation. However, there is a problem that with regard to the tiling display device, the cost becomes high because a plurality of displays is used.

### BRIEF DESCRIPTION OF THE DRAWINGS

FIG. 1 is a front view of a display system according to one embodiment.

FIG. 2 is a top view of the display system according to one embodiment.

FIG. 3 is a side view of the display system according to one embodiment.

FIG. 4 is a diagram showing a relationship between the arrangement of the speakers and the arrangement of the displays.

FIG. 5 is a front view of a display system which is a modified example of FIG. 1.

FIG. 6 is a front view of a display system which is another modified example of FIG. 1.

### DETAILED DESCRIPTION

In general, according to one embodiment, a display system includes a first display and a plurality of second displays arranged around the first display. A resolution of the first display is higher than a resolution of the second displays.

Hereinafter, embodiments will be specifically described with reference to the drawings.

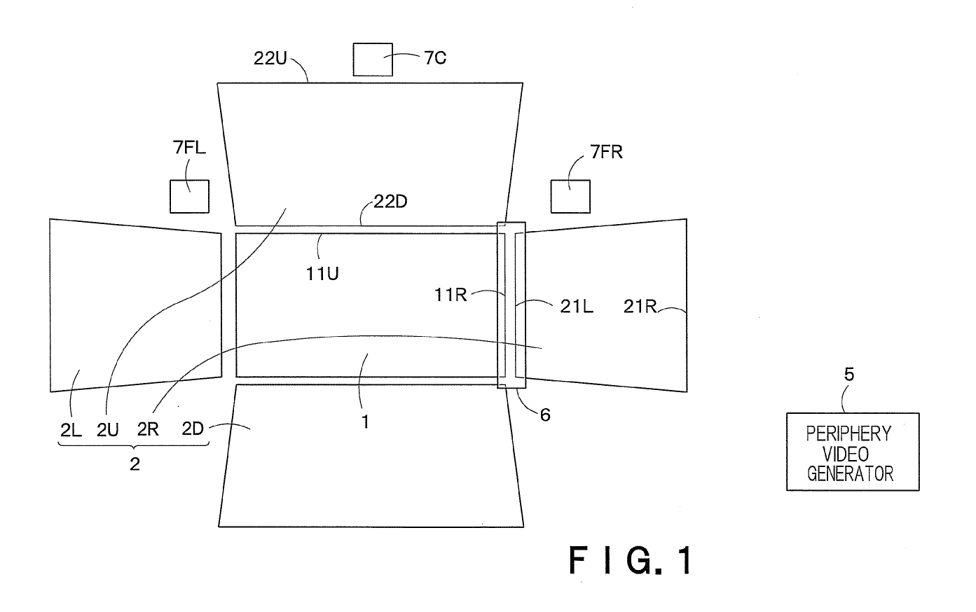

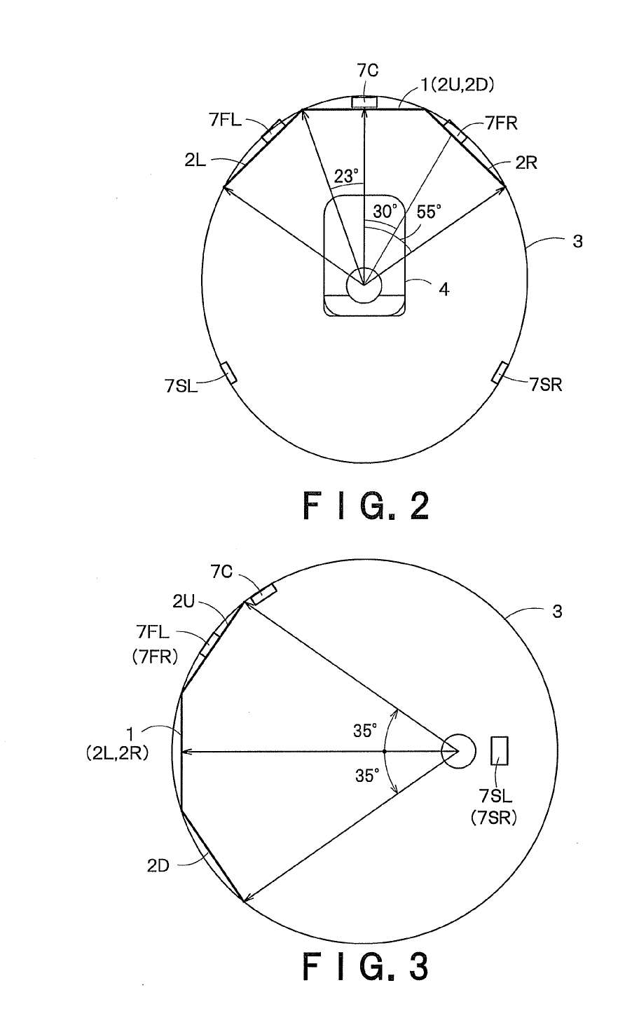

FIG. 1 is a front view of a display system according to one embodiment. FIG. 2 is a top view thereof. FIG. 3 is a side view thereof. The display system is formed by combining a plurality of displays in a cross shape and is called a cross tiling display.

As shown in FIG. 1, the display system includes a central display (first display) 1 and a plurality of peripheral displays (second displays) 2 arranged around the central display. In the example in FIG. 1, the peripheral displays 2 includes a right display (third display) 2R, a left display (fourth display) 2L, an upper display (fifth display) 2U, and a lower display (sixth display) 2D. In other words, the right display 2R and the left display 2L are arranged at both sides of the central display 1 in the horizontal direction. On the other hand, the upper display 2U and the lower display 2D are arranged at both sides of the central display 1 in the vertical direction.

As shown in FIGS. 2 and 3, the central display 1 and the peripheral displays 2 are arranged in a spherical viewing pot 3 and it is desired that a seat 4 is provided at a viewing position to let a user to view the displays from a specific position. For example, the display system is used to display an image of a game machine for one viewer located at a specific viewing position.

A central image source outputted from the game machine is displayed on the central display 1. A peripheral image sources outputted from the same game machine are displayed on the peripheral displays 2.

The display system further includes a peripheral image generator 5 and, for example, when the display system is used to display image content such as a Blu-ray Disc, the display system displays an inputted image source on the central display 1 and the peripheral image generator 5 generates peripheral images from the image source for the central display 1 by using a known wide-view image generation technique and displays the peripheral images on the peripheral displays 2.

The size of the central display 1 and that of the peripheral displays 2 may be the same or different from each other. Each of the central display 1 and the peripheral displays 2 may be formed by a single display panel or formed by forming a tiling of a plurality of display panels, for example, a tiling of 4×4 display panels.

Each of the central display 1 and the peripheral displays 2 is formed by a liquid crystal panel, a plasma display panel, an organic EL panel, or the like.

One of the features of the present embodiment is to use, as the central display 1, a display whose grade is higher than that of the peripheral displays 2. In other words, low grade displays are used as the peripheral displays 2, the number of which is larger. Thereby, it is possible to suppress the cost of the display system.

For example, it is desirable that the resolution of the central display 1 is higher than that of the peripheral displays 2. As a specific example, the central display 1 may have a 4K resolution (horizontal direction 3840 pixels×vertical direction 2160 pixels) and the peripheral displays 2 may have a 2K resolution (horizontal direction 1920 pixels×vertical direction 1080 pixels) which is one half that of the central display 1. In this case, the central display 1 may be formed by combining four display panels having the 2K resolution. The resolution of the peripheral displays 2 is low, so that it is possible to reduce processing load of a peripheral image generation process of the game machine (not shown in the drawings) and/or processing load of the peripheral image generator 5 when displaying image content.

It is desirable that the contrast ratio of the central display 1 is higher than that of the peripheral displays 2. As a specific example, the contrast ratio of the central display 1 may be 10,000:1 and the contrast ratio of the peripheral displays 2 may be 5,000:1, which is one half that of the central display 1.

Regarding visual characteristics of human beings, the temporal and spatial characteristics of the central visual field are different from those of the peripheral visual field. In the central visual field, it is possible to perceive a slight difference of color difference and contrast, and the resolution of the central visual field is high. On the other hand, in the peripheral visual field, capability of discriminating color difference is low and the resolution is also low. However, the peripheral visual field is not unimportant. The peripheral visual field is excellent at perceiving a motion (in particular, perceiving a motion going away from the central retina) and a positional relationship between objects, so that the peripheral visual field provides psychological effects such as a sense of immersion and a realistic sensation.

Therefore, image at the peripheral visual field, whose quality is lower than that at the central visual field, does not provide feeling of strangeness so much. Thus, when an image is provided to the peripheral visual field, the realistic sensation increases. Considering the visual characteristics, in the present embodiment, a plurality of low-grade peripheral displays 2 are used, and thus, it is possible to provide an image with realistic sensation while suppressing increase of the cost.

The sensitivity of human beings to the brightness is high, so that it is desirable that the maximum brightness value of the central display 1 and the maximum brightness value of the peripheral displays 2 are the same as much as possible. Thus, for example, the brightness values are both 500 cd/m². Both maximum brightness values are set to substantially the same at least at the time of shipping. It may be unavoidable that the maximum brightness values differentiate from each other due to subsequent degradation and the like.

Here, the right display 2R, the left display 2L, the upper display 2U, and the lower display 2D are arranged at the right, left, upper, and lower sides of the central display 1, respectively. Specifically, as shown in FIG. 1, the right side 11R of the central display 1 and the left side 21L of the right display 2R face each other. It is desirable that the right side 11R of the central display 1 and the left side 21L of the left display 2L are in contact with each other, however, they may be somewhat separated from each other. This is because even if there is a gap between the displays, the gap is not at the center of the visual field, so that the gap is not so much recognized. The same applies to the upper display 2U, the left display 2L, and the lower display 2D.

Each of the normal central display 1 and the normal peripheral displays 2 includes one or a plurality of display panels and a bezel that surrounds the display panel or the display panels. When the displays are in contact with each other, an edge optical member 6 like a rod lens may be used so that the bezel, where no image is displayed, is difficult to be recognized.

Considering the arrangement of speakers described later, it is desirable that no peripheral display is provided at the upper-right, lower-right, upper-left, and lower-left of the central display 1.

In order to present an image with a more realistic sensation, as shown in FIGS. 1 to 3, it is desirable to arrange the peripheral displays 2 at a tilt along the viewing pot 3 up to areas at which the realistic sensation effect by the wide viewing angle is saturated so that the peripheral displays 2 surround the central display 1. In other words, it is desirable that the peripheral display 2 slants from the central display 1 to face the viewing position.

Specifically, the right side 11R of the central display 1 and the left side 21L of the right display 2R are on the substantially same vertical plane, however, the right side 21R of the right display 2R is located at a position closer to the viewing position. Similarly, the upper side 11U of the central display 1 and the lower side 22D of the upper display 2U are on substantially the same vertical plane, however, the upper side 22U of the upper display 2U is located at a position closer to the viewing position. The same applies to the left display 2L and the lower display 2D.

The peripheral displays 2 are slantwise arranged in this way, so that it is possible to obtain a highly realistic sensation in particular from an image advancing from the back to the front of the display system.

Considering the viewing angle of a human being, as shown in FIG. 2, it is desirable to arrange the central display 1 so as to cover the horizontal viewing angle of a range of ±23 degrees from the viewing position and arrange the right display 2R and the left display 2L so as to cover the horizontal viewing angle of a range of ±55 degrees from the viewing position in the viewing pot 3. The self-motion perception by an image is significantly affected by the horizontal visual field, so that it is important to adjust, in particular, an angle of view in the horizontal direction. As shown in FIG. 3, it is desirable to arrange the upper display 2U and the lower display 2D so as to cover the vertical viewing angle of a range of ±35 degrees from the viewing position in the viewing pot 3.

Further, in order to improve the realistic sensation, it is desirable that the central display 1 displays a stereoscopic image by a polarization glasses manner or an autostereoscopic manner, and further the peripheral displays 2 may display a stereoscopic image.

The display system may include one or a plurality of speakers, for example, a center speaker 7C, a front right speaker (first speaker) 7FR, a front left speaker (second speaker) 7FL, a surround right speaker 7SR, and a surround left speaker 7SL. In the examples in FIGS. 1 to 3, the center speaker 7C is arranged in front of the viewing position and above the upper display 2U. The front right speaker 7FR is arranged in front right of the viewing position and at the upper right of the central display 1 (in other words, above the right display 2R and at the right of the upper display 2U). The front left speaker 7FL is arranged in front left of the viewing position and at the upper left of the central display 1 (in other words, above the left display 2L and at the left of the upper display 2U). The surround right speaker 7SR and the surround left speaker 7SL are arranged at a right back position and a left back position of the viewing position, respectively. A subwoofer (not shown in the drawings) may be arranged at an arbitrary position.

As shown in FIG. 2, it is said to be ideal to arrange the front right speaker 7FR at an angle of 30 degrees from the viewing position and arrange the front left speaker 7FL at an angle of −30 degrees from the viewing position. In the present embodiment, no peripheral display is arranged at the upper right and the upper left of the central display 1, so that it is possible to arrange the front right speaker 7FR and the front left speaker 7FL at the ideal positions. The speakers will be described in more detail below.

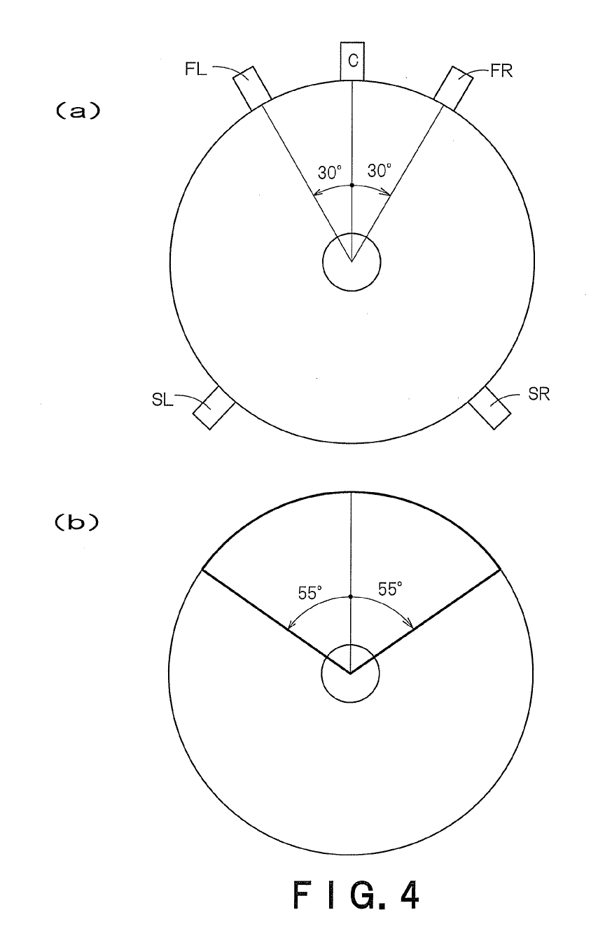

FIG. 4 is a diagram showing a relationship between the arrangement of the speakers and the arrangement of the displays. As described above, it is said to be ideal to arrange the front right speaker FR and the front left speaker FL at an angle of ±30 degrees from the viewing position (FIG. 4(a)). On the other hand, it is said that the self-motion perception is saturated at an angle of view of 110 degrees, so that it is desirable to arrange the front right speaker FR and the front left speaker FL so as to cover the horizontal viewing angle of a range of 110 degrees from the viewing position (FIG. 4(b)). Therefore, it is difficult for the method which forms a tiling of a plurality of displays in a matrix form to achieve appropriate arrangement positions of the speakers and appropriate arrangement positions of the displays at the same time.

On the other hand, in the present embodiment, as shown in FIG. 1, the peripheral displays 2 are arranged in a cross shape (so as to cross each other). Therefore, there are areas in which no peripheral display is arranged at the upper right and the upper left as seen from the viewing position, so that it is possible to appropriately arrange the front right speaker 7FR and the front left speaker 7FL in these areas.

The displays and the speakers can be arranged in ideal positions, so that a viewer sitting on the seat 4 can obtain a highly realistic sensation realized by a different sensation integration mechanism with a highly realistic image and a highly realistic sound.

As described above, in the present embodiment, the high-grade central display 1 and the low-grade peripheral displays 2 are used. Therefore, it is possible to realize a highly realistic sensation with low cost.

No peripheral display is arranged at the upper-right, lower-right, upper-left, and lower-left of the central display 1. Therefore, it is possible to arrange the front right speaker 7FR and the front left speaker 7FL at ideal positions in empty areas. Thereby, it is possible to realize a highly realistic sensation by a synergistic effect of visual and auditory senses.

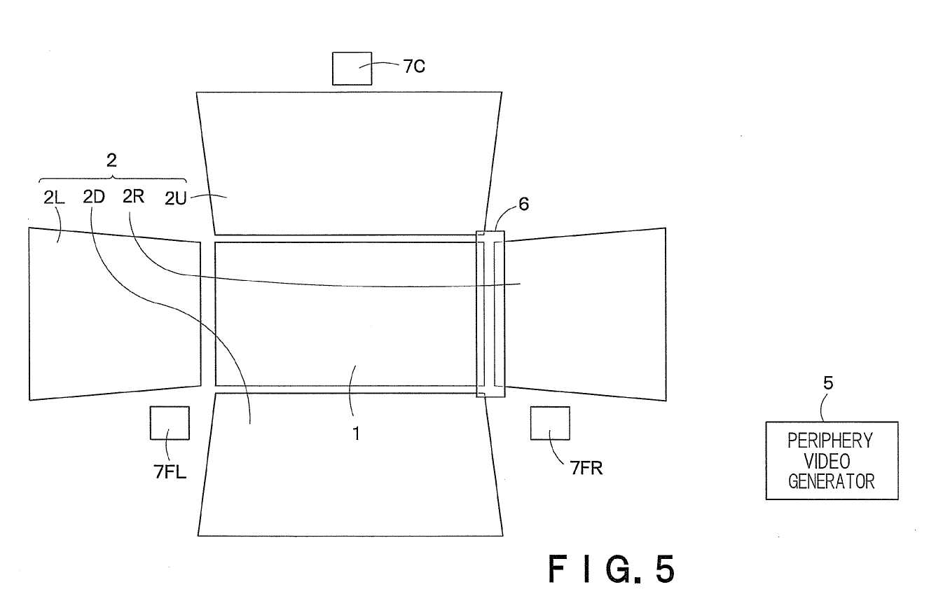

Hereinafter, a modified example will be described. Although an example is shown in FIG. 1 in which the front right speaker 7FR and the front left speaker 7FL are arranged above the right display 2R and the left display 2L respectively, as shown in FIG. 5, the speakers may be arranged below the displays respectively.

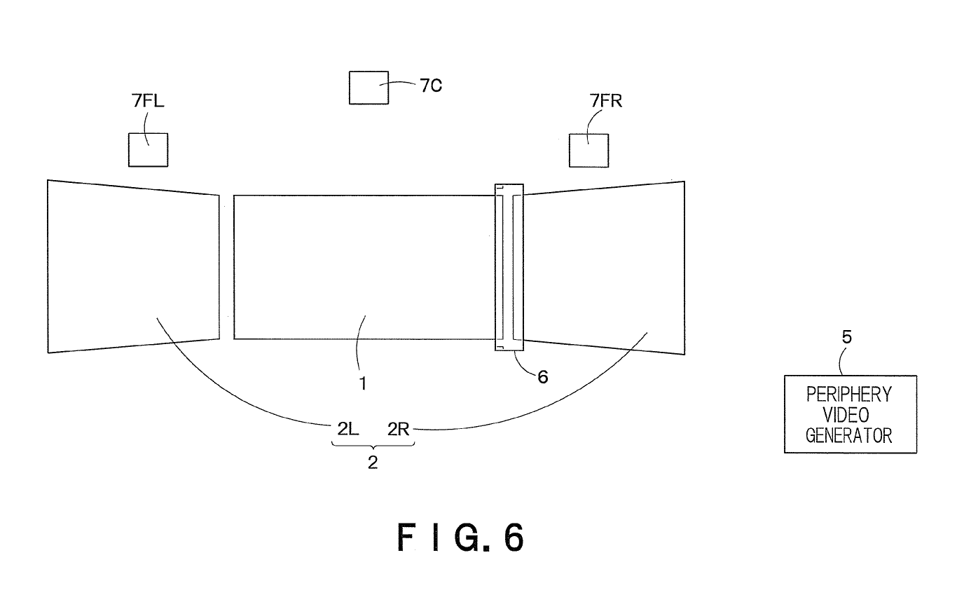

Further, as shown in FIG. 6, the peripheral displays 2 may be formed by the right display 2R the left display 2L, which are arranged at the right and left of the central display 1 respectively, and the upper display and the lower display may be omitted. Further, the right display 2R the left display 2L may be arranged diagonally upward or diagonally downward from the central display 1 instead of being arranged just beside the central display 1.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

Based on the above described embodiments, following display systems can be conceivable as examples.
(Appendix 1). A display system comprising:

a first display (1); and

a plurality of second displays (2) arranged around the first display (1),

wherein a resolution of the first display (1) is higher than a resolution of the second displays (2).
(Appendix 2). The system of appendix 1, wherein a contrast ratio of the first display (1) is higher than a contrast ratio of the second displays (2).
(Appendix 3). The system of appendix 1, a maximum brightness value of the first display (1) is substantially equal to a maximum brightness value of the second displays (2).
(Appendix 4). The system of appendix 1, wherein the first display (1) is configured to display a stereoscopic image.
(Appendix 5). The system of appendix 1, wherein the second displays (2) are arranged at a tilt so as to surround the first display (1).
(Appendix 6). The system of appendix 1, wherein the second displays (2) comprise a third display (2R) and a fourth display (2L) arranged at respective both sides of the first display in a horizontal direction.
(Appendix 7). The system of appendix 6, wherein the third display (2R) and the fourth display (2L) are arranged so as to cover a horizontal viewing angle of a range of substantially ±55 degrees from a viewing position.
(Appendix 8). The system of appendix 1, wherein the second displays (2) comprise:

a third display (2R) and a fourth display (2L) arranged at respective both sides of the first display (1) in a horizontal direction; and

a fifth display (2U) and a sixth display (2D) arranged at respective both sides of the first display (1) in a vertical direction.
(Appendix 9). The system of appendix 8, wherein the fifth display (2U) and the sixth display (2D) are arranged so as to a cover vertical viewing angle of a range of substantially ±35 degrees from a viewing position.
(Appendix 10). The system of appendix 1, wherein the first display (1) is arranged so as to cover a horizontal viewing angle of a range of ±23 degrees from a viewing position.
(Appendix 11). The system of appendix 1, wherein the second displays (2) comprise a third display (2R) and a fourth display (2L) arranged at respective both sides of the first display in a horizontal direction, and

the display system comprises:

a first speaker (7FR) arranged above or under the third display (2R); and

a second speaker (7FL) arranged above or under the fourth display (2L).
(Appendix 12). The system of appendix 11, wherein the first speaker (7FR) and the second speaker (7FL) are arranged at substantially ±30 degrees from a viewing position.
(Appendix 13). The system of appendix 1, wherein the second displays (2) comprise a third display (2R) and a fourth display (2L) arranged at respective both sides of the first display (1) and so as to cover a horizontal viewing angle of a range of substantially ±55 degrees from a viewing position,

the display system comprises:

a first speaker (7FR) arranged above or under the third display (2R) and at substantially 30 degrees from the viewing position; and

a second speaker (7FL) arranged above or under the fourth display (2L) and at substantially -30 degrees from the viewing position.
(Appendix 14). The system of appendix 1 further comprising a periphery image generator (6) configured to generate a periphery image displayed on the second displays (2) from an image source displayed on the first display (1).
(Appendix 15). The system of appendix 1, wherein the first display (1) and the second displays (2) are arranged in a viewing pot (3).
(Appendix 16). The system of appendix 15, the viewing pot (3) has a substantially spherical shape, and the second displays (2) are arranged at a tilt along the viewing pot (3).
(Appendix 17). The system of appendix 1, wherein the first display (1) and each of the second displays (2) comprise a display panel and a bezel surrounding the display panel, and the display system further comprises an optical member (6) to suppress the bezel to be recognized.

1. A display system comprising:
a first display;
a plurality of second displays arranged around the first display;
a first speaker; and
a second speaker,
wherein a resolution of the first display is higher than a resolution of the second displays,
the second displays comprise:
a third display and a fourth display arranged at respective both sides of the first display in a horizontal direction; and
a fifth display arranged above the first display,
the first speaker is arranged above or under the third display, and
the second speaker is arranged above or under the fourth display.

2. The system of claim 1, wherein a contrast ratio of the first display is higher than a contrast ratio of the second displays.

3. The system of claim 1, a maximum brightness value of the first display is substantially equal to a maximum brightness value of the second displays.

4. The system of claim 1, wherein the first display is configured to display a stereoscopic image.

5. The system of claim 1, wherein the second displays are arranged at a tilt so as to surround the first display.

6. The system of claim 1, wherein the third display and the fourth display are arranged so as to cover a horizontal viewing angle of a range of substantially 55 degrees from a viewing position.

7. The system of claim 1, wherein the second displays comprise
a sixth display arranged under the first display.

8. The system of claim 7, wherein the fifth display and the sixth display are arranged so as to a cover vertical viewing angle of a range of substantially 35 degrees from a viewing position.

9. The system of claim 1, wherein the first display is arranged so as to cover a horizontal viewing angle of a range of 23 degrees from a viewing position.

10. The system of claim 1, wherein the first speaker and the second speaker are arranged at substantially 30 degrees from a viewing position.

11. The system of claim 1, wherein the third display and the fourth display are arranged so as to cover a horizontal viewing angle of a range of substantially 55 degrees from a viewing position,
the first speaker is arranged at substantially 30 degrees from the viewing position; and
the second speaker is arranged at substantially −30 degrees from the viewing position.

12. The system of claim 1 further comprising a periphery image generator configured to generate a periphery image displayed on the second displays from an image source displayed on the first display.

13. The system of claim 1, wherein the first display and the second displays are arranged in a viewing pot.

14. The system of claim 13, the viewing pot has a substantially spherical shape, and the second displays are arranged at a tilt along the viewing pot.

15. The system of claim 1, wherein the first display and each of the second displays comprise a display panel and a bezel surrounding the display panel, and
the display system further comprises an optical member to suppress the bezel to be recognized.
